(19) United States
(12) Patent Application Publication
(10) Pub. No.: US 2004/0210437 A1
(43) Pub. Date: Oct. 21, 2004

(54) Semi-discrete utterance recognizer for carefully articulated speech

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/413,375

(22) Filed: Apr. 15, 2003

(51) Int. Cl. G10L 15/04

(52) U.S. Cl. 704/251

(57) ABSTRACT

A method for performing speech recognition of a user's speech includes performing a first speech recognition process on each utterance of the user's speech, using acoustic models that are based on training data of non-discrete utterances. The method also includes performing a second speech recognition process on each utterance of the user's speech, using acoustic models that are based on training data of discrete utterances. The method further includes obtaining a first match score for each utterance of the user's speech from the first speech recognition process and obtaining a second match score for each utterance of the user's speech from the second speech recognition process. The method also includes determining a highest match score from the first and second match scores. The method further includes providing a speech recognition output for the user's speech, based on highest match scores of each utterance as obtained from the first and second speech recognition processes.

### DESCRIPTION OF THE RELATED ART

Conventional speech recognition systems are very useful in performing speech recognition of speech spoken normally, that is, speech made at a normal speaking rate and at a normal speaking volume. For example, for speech recognition systems that are used to recognize speech made by someone who is dictating, that person is instructed to speak in a normal manner so that the speech recognition system will properly interpret his or her speech.

One such conventional speech recognition system is Dragon NaturallySpeaking™, or NatSpeak™, which is a continuous speech, general purpose speech recognition system sold by Dragon Systems of Newton, Mass.

When someone uses NatSpeak™ when dictating, that person is instructed to speak normally, not too fast and not too slow. As a user of NatSpeak™ speaks, the user can view the speech-recognized text on a display. When an incorrect speech recognition occurs, the user can then invoke an error correction mode in order to go back and fix an error in the speech-recognized text. For example, there are provided command mode keywords that the user can use to invoke the error correction mode, such as “Select ‘word’”, whereby “Select” invokes the command mode and ‘word’ is the particular word shown on the display that the user wants to be corrected. Alternatively, the user can invoke the error correction mode by uttering “Select from ‘beginning word’ to ‘ending word’”, whereby a string of text between and including the beginning and ending words would be highlighted on the display for correction. With the user making such an utterance, the speech recognizer checks recently processed text (e.g., the last four lines of the text shown on the display) to find the word to be corrected. Once the word to be corrected is highlighted on the display, the user can then speak the corrected word so that the proper correction can be made. Once the correction has been made in the error correction mode, the user can then cause the speech recognizer to go back to the normal operation mode in order to continue with more dictation.

For example, as the user is dictating text, the user notices, on a display that shows the speech recognized text, that the word “hypothesis” was incorrectly recognized by the speech recognizer as “hypotenuse”. The user then utters “Select ‘hypotenuse”, to enter the error correction mode. The word ‘hypotenuse’ is then highlighted on the display. The user then utters ‘hypothesis’, and the text is corrected on the display to show ‘hypothesis’ where ‘hypotenuse’ previously was shown on the display. The user can then go back to the normal dictation mode.

A problem exists in such conventional systems in that after the user invokes the error correction mode, the user tends to speak the proper word (to replace the improperly recognized word) more carefully and slowly than normal. For example, once the error correction mode has been entered by a user when the user notices that the speech recognized text provided on a display shows the word “five” instead of the word “nine” spoken by the user, the user may state “nnnniiiiinnnneee” (this an extreme example to more clearly illustrate the point) as the word to replace the corresponding improperly speech recognized output “five”. The conventional speech recognition system may not be able to properly interpret the slowly spoken word “nnnniiiinnnneeee”, since such a word spoken in a very slow manner by the user does not exist in an acoustic model dictionary of words stored as reference words by the speech recognition system. Accordingly, it may take several attempts by the user to correct improperly recognized words in a conventional speech recognition system, leading to loss of time and leading to frustration in using such a system by the user.

The present invention is directed to overcoming or at least reducing the effects of one or more of the problems set forth above.

### SUMMARY OF THE INVENTION

According to one embodiment of the invention, there is provided a method for performing speech recognition of a user's speech. The method includes a step of performing a first speech recognition process on each utterance of the user's speech, using a first grammar with acoustic models that are based on training data of non-discrete utterances. The method also includes performing a second speech recognition process on each utterance of the user's speech, using a second grammar with acoustic models that are based on training data of discrete utterances. The method further includes obtaining a first match score for each utterance of the user's speech from the first speech recognition process and obtaining a second match score for each utterance of the user's speech from the second speech recognition process, and determining a highest match score from the first and second match scores. The method still further includes providing a speech recognition output for the user's speech, based on highest match scores of each utterance as obtained from the first and second speech recognition processes.

In one configuration, each utterance corresponds to user's speech between pauses of at least a predetermined duration (e.g., longer than 250 milliseconds), and in another configuration, each utterance corresponds to a particular number of adjacent frames (where each frame is 10 milliseconds in duration) that is used to divide the user's speech into segments.

According to another embodiment of the invention, there is provided a method for performing speech recognition of a user's speech. The method includes a step of performing a first speech recognition process on the user's speech in a first mode of operation, using a first grammar with acoustic models that are based on training data of non-discrete utterances. The method also includes performing a second speech recognition process on the user's speech in a second mode of operation, using a second grammar with acoustic models that are based on training data of discrete utterances, and wherein only one of the first and second speech recognition processes is capable of being operative at any particular moment in time. The method further includes providing a speech recognition output for the user's speech, based on respective outputs from the first and second speech recognition processes.

In one configuration, the first mode of operation corresponds to a normal dictation mode of a speech recognizer, and the second mode of operation corresponds to an error correction mode of the speech recognizer.

According to yet another embodiment of the invention, there is provided a system for performing speech recognition of a user's speech. The system includes a control unit for receiving the user's speech and for determining whether or not an error correction mode, or some other mode in which slower speech is expected, is to be initiated based on utterances made in the user's speech, and to output a control signal indicative of whether or not the slower speech mode is in operation. The system also includes a first speech recognition unit configured to receive the user's speech and to perform a first speech recognition processing on the user's speech when the control signal provided by the control unit indicates that the slower speech mode is not in operation. The system further includes a second speech recognition unit configured to receive the user's speech and to perform a second speech recognition processing on the user's speech when the control signal provided by the control unit indicates that the slower speech mode is in operation. The second speech recognition unit utilizes training data of speech that is spoken in a slower word rate than training data of speech used by the first speech recognition unit.

According to another embodiment of the invention, there is provided a system for performing speech recognition of a user's speech. The system includes a first speech recognition unit configured to receive the user's speech and to perform a first speech recognition processing on the user's speech based in part on training data of speech spoken at a first speech rate or higher, the first speech recognition unit outputting a first match score for each utterance of the user's speech. The system also includes a second speech recognition unit configured to receive the user's speech and to perform a first speech recognition processing on the user's speech based in part on training data of speech spoken at a speech rate lower than the first speech rate, the second speech recognition unit outputting a second match score for each utterance of the user's speech. The system further includes a comparison unit configured to receive the first and second match scores and to determine, for each utterance of the user's speech, which of the first and second match scores is highest. A speech recognition output corresponds to a highest match score for each utterance of the user's speech, as output from the comparison unit.

According to yet another embodiment of the invention, there is provided a program product having machine readable code for performing speech recognition of a user's speech, the program code, when executed, causing a machine to perform the step of performing a first speech recognition process on each utterance of the user's speech, using a first grammar with acoustic models that are based on training data of non-discrete utterances. The program code further causes the machine to perform the step of performing a second speech recognition process on each utterance of the user's speech, using a second grammar with acoustic models that are based on training data of discrete utterances. The program code also causes the machine to perform the step of obtaining a first match score for each utterance of the user's speech from the first speech recognition process and obtaining a second match score for each utterance of the user's speech from the second speech recognition process. The program code further causes the machine to perform the step of determining a highest match score from the first and second match scores. The program code also causes the machine to perform the step of providing a speech recognition output for the user's speech, based on highest match scores of each utterance as obtained from the first and second speech recognition processes.

### BRIEF DESCRIPTION OF THE DRAWINGS

The foregoing advantages and features of the invention will become apparent upon reference to the following detailed description and the accompanying drawings, of which:

FIG. 1 is a flow chart of a speech recognition method according to a first embodiment of the invention;

FIG. 2 is a block diagram of a speech recognition system according to the first embodiment of the invention;

FIG. 3 is a flow chart of a speech recognition method according to a second embodiment of the invention; and

FIG. 4 is a block diagram of a speech recognition system according to the second embodiment of the invention.

### DETAILED DESCRIPTION OF SPECIFIC EMBODIMENTS

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

The following terms may be used in the description of the invention and include new terms and terms that are given special meanings.

“Linguistic element” is a unit of written or spoken natural or artificial language. In some embodiments of some inventions, the “language” may be a purely artificial construction with allowed sequences of elements determined by a formal grammar. In other embodiments, the language will be either a natural language or at least a model of a natural language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval. As an element within the surrounding sequence of speech elements, each speech element is also a linguistic element.

“Priority queue” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Stack decoder” is a search system that uses a priority queue. A stack decoder may be used to implement a best first search. The term stack decoder also refers to a system-implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates. The acoustic models depend on the selection of training data that is used to train the models. For example, acoustic models that represent the same set of phonemes will be different if the models are trained on samples of single words or discrete utterance speech then if the models are trained on full sentence continuous speech.

“Dictionary” is a list of linguistic elements with associated information. The associated information may include meanings or other semantic information associated with each linguistic element. The associated information may include parts of speech or other syntactic information. The associated information may include one or more phonemic or phonetic pronunciations for each linguistic element.

“Acoustic model dictionary” is a dictionary including phonemic or phonetic pronunciations and the associated acoustic models. In some embodiments, the acoustic model dictionary may include acoustic models that directly represent the probability distributions of each of the speech elements without reference to an intermediate phonemic or phonetic representation. Because the acoustic model dictionary includes the acoustic models, it depends on the selection of the training samples that are used to train the acoustic models. In particular, an acoustic model dictionary trained on discrete utterance data will differ from an acoustic model dictionary trained only on continuous speech, even if the two dictionaries contain the same lists of speech elements.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal sequence of linguistic elements.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Hypothesis” is a hypothetical proposition partially or completely specifying the values for some set of speech elements. Thus, a hypothesis is typically a sequence or a combination of sequences of speech elements. Corresponding to any hypothesis is a sequence of models that represent the speech elements. Thus, a match score for any hypothesis against a given set of acoustic observations, in some embodiments, is actually a match score for the concatenation of the models for the speech elements in the hypothesis.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Phoneme” is a single unit of sound in spoken language, roughly corresponding to a letter in written language.

The present invention according to at least one embodiment is directed to a speech recognition system and method that is capable of recognizing carefully articulated speech as well as speech spoken at a normal tempo or nearly normal tempo.

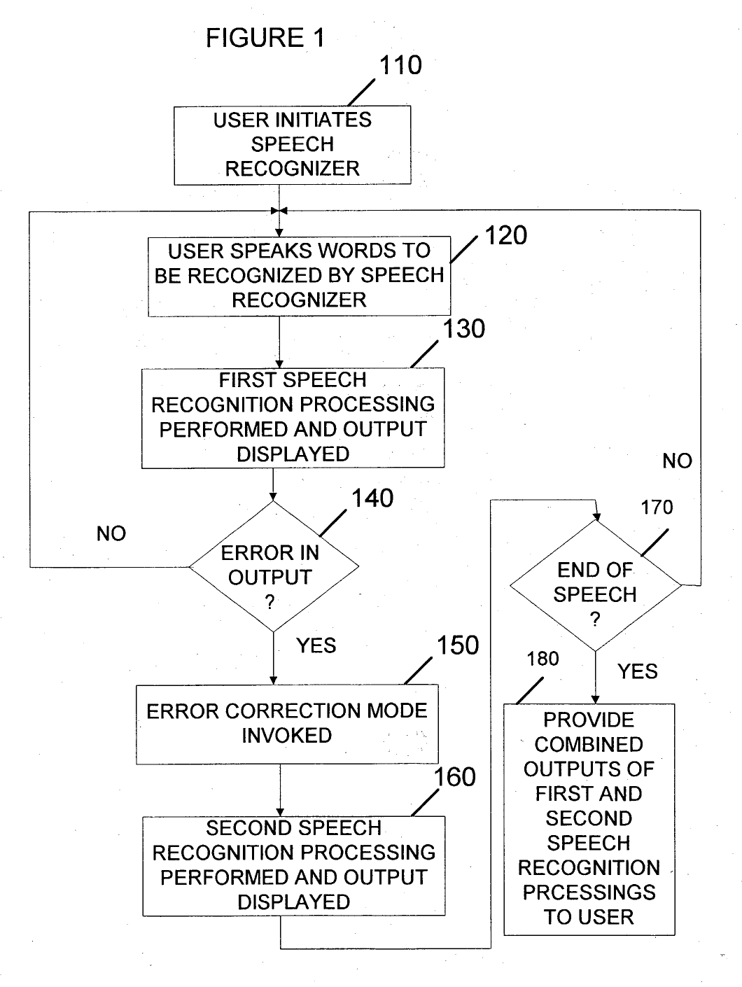

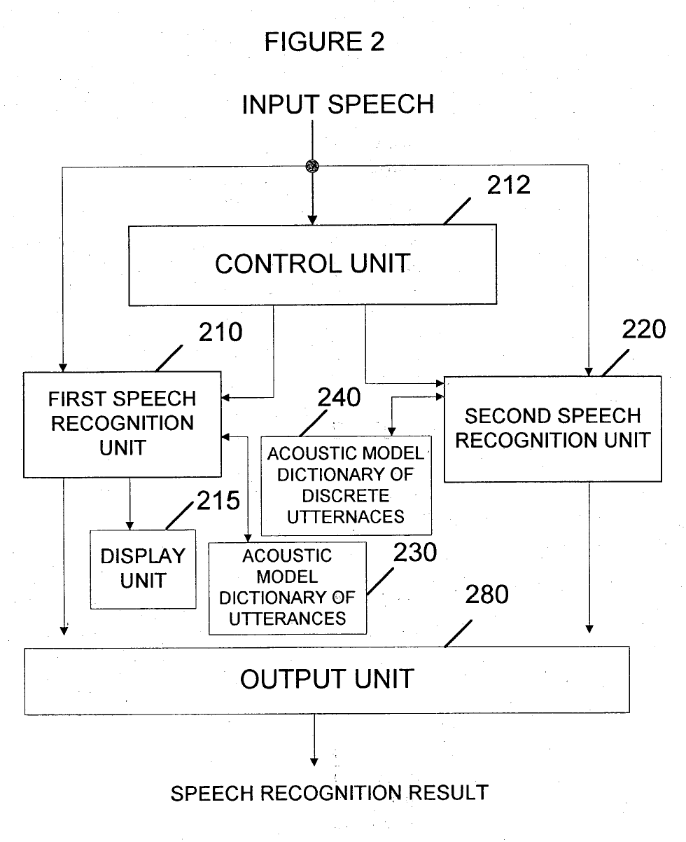

In a first embodiment, as shown in flow chart form in FIG. 1 and in block diagram form in FIG. 2, a user initiates a speech recognizer as shown by step 110 in FIG. 1, in order to obtain a desired service, such as obtaining a text output of dictation uttered by the user.

Once the speech recognizer is initiated, the user speaks words to be recognized by the speech recognizer, as shown by step 120 in FIG. 1. In a normal mode of operation, a first speech recognizer (see the first speech recognizer 210 in FIG. 2, which is activated and deactivated by the Control Unit 212) performs a speech recognition processing of each utterance (or speech element) of the user's speech, and displays the output to the user (via display unit 215 in FIG. 2), as shown by step 130 in FIG. 1.

When the user determines that there is an error in the speech recognized output that is displayed to the user, as given by the “Yes” path in step 140, then the user invokes the error correction mode of the speech recognizer, as shown in step 150. As shown in FIG. 2, a control unit 212 is provided to detect initiation and completion of the error correction mode. The initiation of the error correction mode may be made by any of a variety of ways, such as by speaking a particular command (e.g., the user speaking “Enter Error Correction Mode”, or by the user speaking a command such as “Select ‘alliteration’” or some other word to be corrected), or by pressing a particular button on a speech recognition unit in order to enter the error correction mode. In any event, the user knows how to enter the error correction mode based on the user reviewing an operational manual provided for the speech recognizer, for example.

Initiation of the error correction mode causes the speech recognizer according to the first embodiment to utilize a second speech recognizer (see the second speech recognizer 220 in FIG. 2, which is activated and deactivated by the Control Unit 212) to perform speech recognition of the user's utterances made during the error correction mode, as shown by step 160, whereby the speech recognition output may be textually displayed to the user for verification of those results. The second speech recognizer 220 utilizes an acoustic model dictionary of discrete utterances (also referred to herein as a second reference acoustic model dictionary) 240 to properly interpret the user's speech made during the error correction mode. The acoustic model dictionary of discrete utterances 240 includes training data of a plurality of speaker's discrete utterances, such as single words or short phrases being spoken at a slow rate by different speakers. This information is different from the acoustic model dictionary of utterances (also referred to herein as a first reference acoustic model dictionary) 230 that is utilized by the first speech recognizer 210 during normal (non-error correction mode) operation of the speech recognition system.

Typically the phonemes in a single word or short phrase are spoken more slowly even when the speaker makes no conscious effort to do so. If the speaker gives the utterance extra emphasis, as is likely for an error correction command, the speech will be even slower. The slow or emphasized speech will also differ from normal long utterance continuous speech in other ways that may affect the observed acoustic parameters.

If the end of the input speech has been reached, as shown by the Yes path in step 170, the outputs of the first and second speech recognizers 210, 220 are combined and provided to the user as the complete speech recognition output, as shown by step 180. If the end of the input speech has not been reached, as shown by the No path in step 170, then the process goes back to step 120 to process a new portion of the input speech.

By way of example, the acoustic model dictionary of discrete utterances 240 utilized by the second speech recognizer 220 includes a digital representation of words and short phrases spoken by training speakers in a slower manner than the corresponding digital representation of the training utterances spoken by speakers in a training mode that are stored in the acoustic model dictionary of utterances 230 utilized by the first speech recognizer 210. That is, the words and phrases stored in the acoustic model dictionary of utterances 230 corresponds to digital representations of words and phrases uttered by speakers in a training mode at a normal tempo or word rate.

Based on the outputs from both the first and second speech recognizers 210, 220, a speech recognition result is obtained in a step 180. In the first embodiment, either the first speech recognizer 210 operates on a portion of the user's speech or the second speech recognizer 220 operates on that same portion of the user's speech, but not both. In FIG. 2, the output unit 280 combines the respective outputs of the first and second speech recognizers 210, 220, to provide a complete speech recognition output to the user, such as by providing a textual output on a display.

A feature of the first embodiment is the utilization of the proper training data for the different speech recognizers that are used to interpret the user's speech. Obtaining a language model and a grammar based on training data is a known procedure to one skilled in the art. In the first embodiment, training data obtained from speakers who are told to speak sentences and paragraphs in a normal speaking rate is used to provide the set of data to be stored in the acoustic model dictionary of utterances 230 that is used by the first speech recognizer 210 as reference data, and training data from speakers who are told to speak particular isolated words and/or short phrases is used to provide the set of data stored in the acoustic model dictionary of discrete utterances 240 that is used by the second speech recognizer 220 as reference data. The isolated words and/or short phrases may be presented to the speakers in the format of error correction or other commands. In one implementation, the speakers may be told to speak in a careful, slow speaking rate. In a second implementation, the slower, more careful speech may be induced merely by the natural tendency for commands to be spoken more carefully.

As mentioned earlier, a user tends to overly articulate words in the error correction mode, which may cause a conventional speech recognizer, such as NatSpeak™, to improperly recognize these overly articulated words. The invention according to the first embodiment provides a speech recognition system and method that can properly recognize overly articulated words as well as normally articulated words.

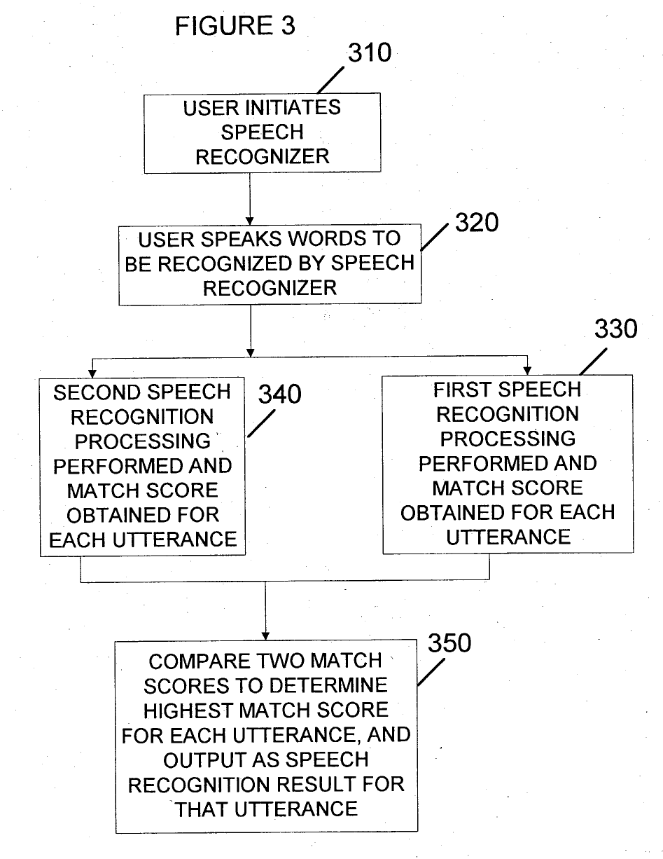

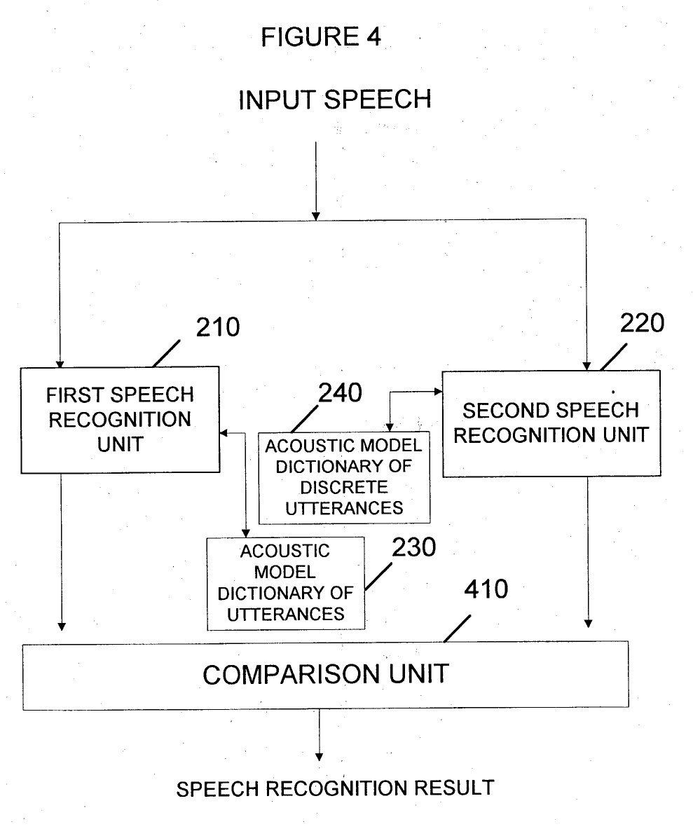

In a second embodiment of the invention, as shown in flow chart form in FIG. 3 and in block diagram form in FIG. 4, the user initiates a speech recognizer as shown by step 310 in FIG. 3, in order to obtain a desired service, such as to obtain a text output of dictation uttered by the user.

Once the speech recognizer is initiated, the user speaks words (as parts of sentences) to be recognized by the speech recognizer, as shown by step 320 in FIG. 3. A first speech recognizer (corresponding to the first speech recognizer 210 in FIG. 4) performs a speech recognition processing of each utterance of the user's speech. In the second embodiment, the output of the speech recognition processing does not necessarily have to be displayed to the user or reviewed by the user at this time.

In one configuration, each utterance of the user's speech is separately processed by the first speech recognizer 210, and a match score is obtained for each utterance based on the information obtained from the first reference acoustic model dictionary 230, as shown by step 330. At the same time, each utterance of the user's speech is separately processed by the second speech recognizer 220, and a match score is obtained for each utterance based on the information obtained from the second reference acoustic model dictionary 240, as shown by step 340.

In a first implementation of the second embodiment, each utterance of the user's speech is defined by way of a pause of at least a predetermined duration (e.g., at least 250 milliseconds) that occurs both before and after the utterance in question. In a second implementation of the second embodiment, each utterance of the user's speech is defined based on that portion of the user's speech that occurs within a frame group corresponding to a particular number of adjacent frames (e.g., 20 adjacent frames, where one frame equals 10 milliseconds in time duration), whereby the user's speech is partitioned into a plurality of consecutive frame groups with one utterance defined for each frame group.

For the two match scores obtained for each speech utterance, a highest match score is determined (by the Comparison Unit 410 in FIG. 4), and is output as a speech recognition result for that speech utterance, as shown by step 340. Therefore, it may be the case that some portions of the user's speech are better matched by way of the first speech recognizer 210, while other portions of the user's speech (e.g., those portions spoken by the user during an error correction mode) are better matched by way of the second speech recognizer 220.

In the second embodiment, unlike the first embodiment, the first speech recognizer 210 performs its speech recognition on the user's speech at the same time and on the same input speech segment that the second speech recognizer 220 performs its speech recognition on the user's speech.

In one possible implementation of the second embodiment, the output of the second speech recognizer 220 is connected to speech output of the first speech recognizer 210 with a small stack decoder, whereby the best scoring hypotheses would appear at the top of the stack of the stack decoder.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “module” or “component” or “unit” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Pseudo Code that may be utilized to implement the present invention according to at least one embodiment is provided below:

1) Run discrete utterance recognizer in parallel to continuous recognizer.

2) Extend discrete utterance recognizer to connected speech with a small stack decoder.

3) Training data is discrete utterances, error correction utterances, and commands.

What is claimed is:

1. A method for performing speech recognition of a user's speech, comprising:
performing a first speech recognition process on each utterance of the user's speech, using acoustic models that are based on training data of non-discrete utterances;
performing a second speech recognition process on each utterance of the user's speech, using acoustic models that are based on training data of discrete utterances;
obtaining a first match score for each utterance of the user's speech from the first speech recognition process and obtaining a second match score for each utterance of the user's speech from the second speech recognition process, determining a highest match score from the first and second match scores; and
providing a speech recognition output for the user's speech, based on highest match scores of each utterance as obtained from the first and second speech recognition processes.

2. The method according to claim 1, wherein each utterance of the user's speech corresponds to portions of the user's speech that exist between pauses of at least a predetermined duration in the user's speech.

3. The method according to claim 1, wherein the user's speech is divided into frames, and wherein each utterance of the user's speech is disposed within a particular group of adjacent frames.

4. A method for performing speech recognition of a user's speech; comprising:
performing a first speech recognition process on the user's speech in a first mode of operation, using acoustic models that are based on training data of non-discrete utterances;
performing a second speech recognition process on the user's speech in a second mode of operation, using acoustic models that are based on training data of discrete utterances, and
providing a speech recognition output for the user's speech, based on respective outputs from the first and second speech recognition processes,
wherein only one of the first and second speech recognition processes is capable of being operative at any particular moment in time.

5. The method according to claim 4, wherein the first mode of operation corresponds to a normal dictation mode of a speech recognizer, and the second mode of operation corresponds to an error correction mode of the speech recognizer.

6. The method according to claim 4, wherein the first mode of operation corresponds to a normal dictation mode of a speech recognizer, and the second mode of operation corresponds to a command and control mode.

7. A system for performing speech recognition of a user's speech; comprising:
a control unit for receiving the user's speech and for determining whether or not an error correction mode is to be initiated based on utterances made in the user's speech, and to output a control signal indicative of whether or not the error correction mode is in operation;
a first speech recognition unit configured to receive the user's speech and to perform a first speech recognition processing on the user's speech when the control signal provided by the control unit indicates that the error correction mode is not in operation; and
a second speech recognition unit configured to receive the user's speech and to perform a second speech recognition processing on the user's speech when the control signal provided by the control unit indicates that the error correction mode is in operation;
wherein the second speech recognition unit utilizes training data of speech that is spoken in a slower word rate than training data of speech used by the first speech recognition unit.

8. The system according to claim 6, further comprising:
a display unit configured to display a textual output corresponding to speech recognition output of the first speech recognition unit,
wherein a user reviews the textual output to make a determination as to whether or not to initiate the error correction mode.

9. A system for performing speech recognition of a user's speech; comprising:
a first speech recognition unit configured to receive the user's speech and to perform a first speech recognition processing on the user's speech based in part on training data of speech spoken at a first speech rate or higher, the first speech recognition unit outputting a first match score for each utterance of the user's speech;
a second speech recognition unit configured to receive the user's speech and to perform a first speech recognition processing on the user's speech based in part on training data of speech spoken at a speech rate lower than the first speech rate, the second speech recognition unit outputting a second match score for each utterance of the user's speech; and
a comparison unit configured to receive the first and second match scores and to determine, for each utterance of the user's speech, which of the first and second match scores is highest,
wherein a speech recognition output corresponds to a highest match score for each utterance of the user's speech, as output from the comparison unit.

10. The system according to claim 9, wherein the second speech recognition unit utilizes training data of speech that is spoken in a slower word rate than training data of speech used by the first speech recognition unit.

11. A program product having machine readable code for performing speech recognition of a user's speech, the program code, when executed, causing a machine to perform the following steps:
performing a first speech recognition process on each utterance of the user's speech, using acoustic models that are based on training data of non-discrete utterances;
performing a second speech recognition process on each utterance of the user's speech, using acoustic models that are based on training data of discrete utterances;
obtaining a first match score for each utterance of the user's speech from the first speech recognition process and obtaining a second match score for each utterance of the user's speech from the second speech recognition process,
determining a highest match score from the first and second match scores; and
providing a speech recognition output for the user's speech, based on highest match scores of each utterance as obtained from the first and second speech recognition processes.

12. The program product according to claim 11, wherein each utterance of the user's speech corresponds to portions of the user's speech that exist between pauses of at least a predetermined duration in the user's speech.

13. The program product according to claim 11, wherein the user's speech is divided into frames, and wherein each utterance of the user's speech is disposed within a particular group of adjacent frames.

14. A program product for performing speech recognition of a user's speech; comprising:
performing a first speech recognition process on the user's speech in a first mode of operation, using acoustic models that are based on training data of non-discrete utterances;
performing a second speech recognition process on the user's speech in a second mode of operation, using acoustic models that are based on training data of discrete utterances, and
providing a speech recognition output for the user's speech, based on respective outputs from the first and second speech recognition processes,
wherein only one of the first and second speech recognition processes is capable of being operative at any particular moment in time.

15. The program product according to claim 14, wherein each utterance of the user's speech corresponds to portions of the user's speech that exist between pauses of at least a predetermined duration in the user's speech.

16. The program product according to claim 14, wherein the first mode of operation corresponds to a normal dictation mode of a speech recognizer, and the second mode of operation corresponds to an error correction mode of the speech recognizer.

17. The program product according to claim 14, wherein the user's speech is divided into frames, and wherein each utterance of the user's speech is disposed within a particular group of adjacent frames.
